(19) United States
(12) Patent Application Publication
(10) Pub. No.: US 2012/0238316 A1
(43) Pub. Date: Sep. 20, 2012

(54) MOBILE PHONE AND COMMUNICATION SYSTEM SWITCHING METHOD

(75) Inventors: YAO-NAN CHANG, Tu-Cheng (TW); JIE CHEN, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 13/157,319

(22) Filed: Jun. 10, 2011

(30) Foreign Application Priority Data
Mar. 17, 2011 (CN) 201110065175.7

(51) Int. Cl. H04W 88/06

(52) U.S. Cl. 455/552.1

(57) ABSTRACT

A mobile phone includes two different communication systems and a current table storing relationship between signal transmission power and current in relation to the two different communication systems. The mobile phone obtains two received signal strength indications (RSSI) in relation to the two different communication systems if the mobile phone requires the voice call service, and then calculates two signal transmission power in relation to the two communication system according to the two RSSI. The mobile phone searches a current table to obtain two current according to the two signal transmission power. The mobile phone compares the two current to select one of the two communication systems which needs a smaller one of the two current to provide the voice call service.

### BACKGROUND

1. Technical Field

Embodiments of the present disclosure relate to mobile phones, and more particularly to a communication system switching method of a mobile phone.

2. Description of Related Art

A dual mode mobile phone supports at least two communication systems, such as a GSM system and a WCDMA system. In the dual mode mobile phone, the communication systems are selected and switched by manual without considering power saving of the mobile phone which is very important for the mobile phone. There remains a heretofore unaddressed need to overcome the limitations described.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of environment and functional modules of a mobile phone of one embodiment of the present disclosure;

FIG. 2 is a schematic diagram of an example of a current table of FIG. 1; and

FIG. 3 is a flowchart of a communication system switching method of one embodiment of the present disclosure.

### DETAILED DESCRIPTION

All of the processes described may be embodied in, and fully automated over, software code modules executed by one or more general purpose computers or processors. The code modules may be stored in any type of computer-readable medium or other storage device. Some or all of the methods may alternatively be embodied in specialized computer hardware or communication apparatus.

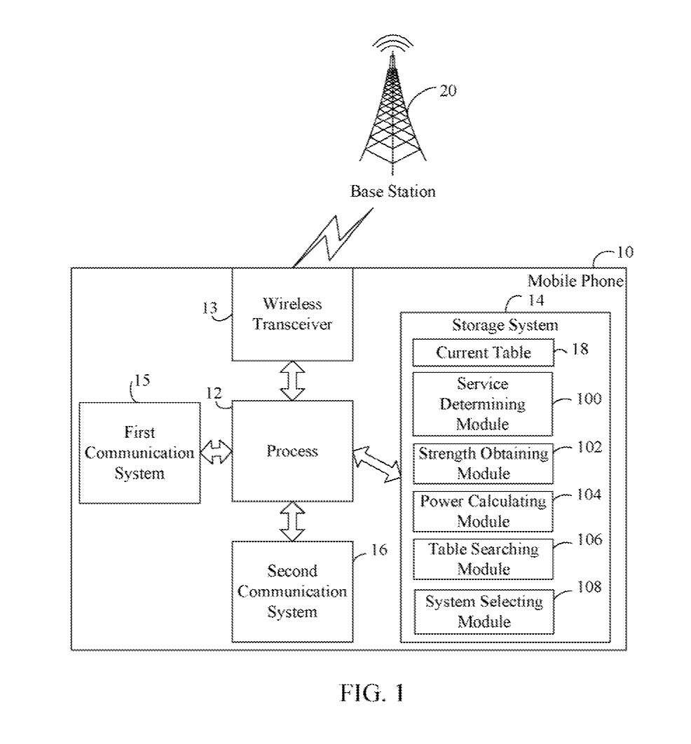

FIG. 1 is a schematic diagram of application environment and functional modules of a mobile phone 10 of one embodiment of the present disclosure. In one embodiment, the mobile phone 10 includes a processor 12, a wireless transceiver 13, a storage system 14, a first communication system 15, and a second communication system 16. In one embodiment, the first communication system 15 is a GSM system. The second communication system 16 is a selected one from a CDMA2000 system, a WCDMA system, a TD-SCDMA system, a LTE system, and a WIMAX system.

The processor 12 controls the wireless transceiver 13 to communicate with a base station 20 with the first communication system 15 or the second communication system 16. In one embodiment, the storage system 14 includes a synchronous dynamic random access memory (SDRAM), a flash memory and other kinds of hardware in which data can be stored.

In one embodiment, the storage system 14 stores a current table 18, a service determining module 100, a strength obtaining module 102, a power calculating module 104, a table searching module 106, and a system selecting module 108. The above modules 100-108 may comprise one or more software programs in the form of computerized codes that are stored in the storage system 14. The computerized codes include instructions that are executable by the processor 12 to provide functions for the modules 100-108.

The current table 18 stores a first relationship between current and signal transmission power in relation to the first communication system 15 and a second relationship between current and signal transmission power in relation to the second communication system 16. In one embodiment, the first relationship and the second relationship are average values over multiple tests of the relationship between current and signal transmission power in relation to the first communication system 15 and the second communication system 16.

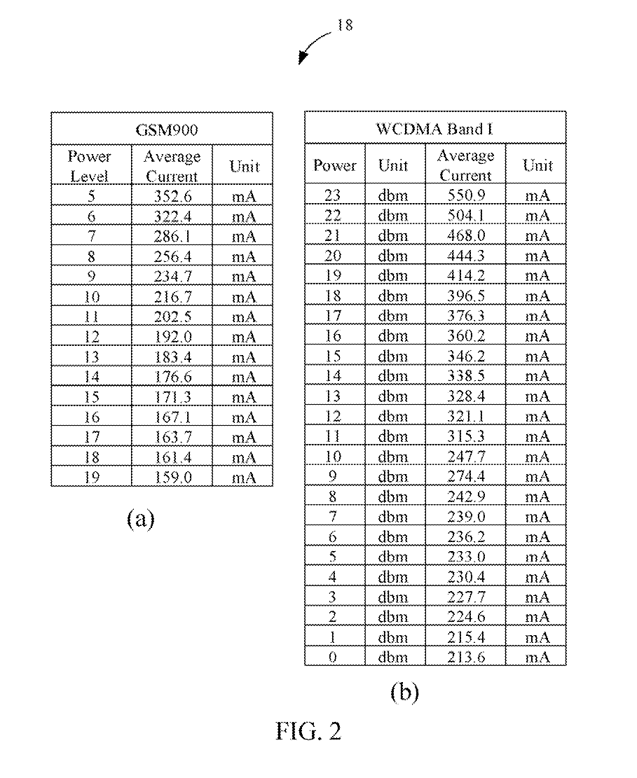

FIG. 2 is a schematic diagram of an example of the current table 18. In the exemplary embodiment of FIG. 2, the first communication system 15 is GSM900, and the second communication system 16 is WCDMA BANDI. Here, the current table 18 includes two relationship tables (a) and (b). The table (a) shows an example of the relationship between current and signal transmission power in relation to GSM900. The table (b) shows an example of the relationship between current and signal transmission power in relation to WCDMA BANDI.

In detail, the relationship table (a) of GSM900 includes a power level field, an average current field, and a current unit field. In the embodiment, each power level, from power level 5 through 19, corresponds to an individual current. For example, a first line of the relationship table (a) indicates GSM900 communication system of the mobile phone 10 requires 352.6 milliampere (mA) current when the signal transmission power is in level 5 by multiple testing in relation to GSM900 communication system. Relationships between the power levels and the signal transmission power are defined by the GSM communication standard.

The relationship table (b) of WCDMA BANDI includes a power field, a power unit field, an average current field, and a current unit field. In the relationship table of WCDMA BANDI, each power, from 23 dbm through 0 dbm, corresponds to an individual current. For example, a first line of the relationship table (b) indicates WCDMA BANDI communication system of the mobile phone 10 requires 550.9 mA current when the signal transmission power of WCDMA BANDI is 23 dbm by multiple testing in relation to WCDMA BANDI communication system.

Referring to FIG. 1, the service determining module 100 determines if the mobile phone 10 requires a voice call service according to user input, such as dialling a telephone number to call someone. The strength obtaining module 102 obtains a first received signal strength indication (RSSI) in relation to the first communication system 15 and a second RSSI in relation to the second communication system 16 if the mobile phone 10 requires the voice call service.

In one embodiment, the RSSI is related to the base station 20. If two base stations respectively communicating with the first communication system 15 and the second communication system 16 are different, the first RSSI and the second RSSI are different.

The power calculating module 104 calculates a first signal transmission power in relation to the first communication system 15 according to the first RSSI and a second signal transmission power in relation to the second communication system 16 according to the second RSSI.

The table searching module 106 searches the current table 18 to obtain a first current according to the first signal transmission power and the first relationship and to obtain a second current according to the second signal transmission power and the second relationship. In the example of GSM900 communication system, the table searching module 106 transforms the first signal transmission power to the corresponding power level and then searches the relationship table (a) according to the corresponding power level to obtain the corresponding current.

Subsequently, the system selecting module 108 compares the first current and the second current and selects one of the communication systems which needs a smaller current to provide the voice call service. In one embodiment, the system selecting module 108 selects the first communication system 15 to provide the voice call service if the first current is smaller than the second current, or selects the second communication system 16 to provide the voice call service if the first current is larger than the second current.

In the example of FIG. 2, if the current required by GSM900 is smaller than the current required by WCDMA BANDI, the system selecting module 108 selects GSM900 to provide the voice call service. If the current required by GSM900 is larger than the current required by WCDMA BANDI, the system selecting module 108 selects WCDMA BANDI to provide the voice call service.

Further, if the mobile phone 10 requires a standby service, the system selecting module 108 selects the first communication system 15 to provide the standby service because the first communication system usually requires less current than that of other communication systems when the mobile phone 10 is in a standby mode. If the mobile phone 10 requires a data transmission service, the system selecting module 108 selects the second communication system 16 to provide the data transmission service to assure data transmission efficiency.

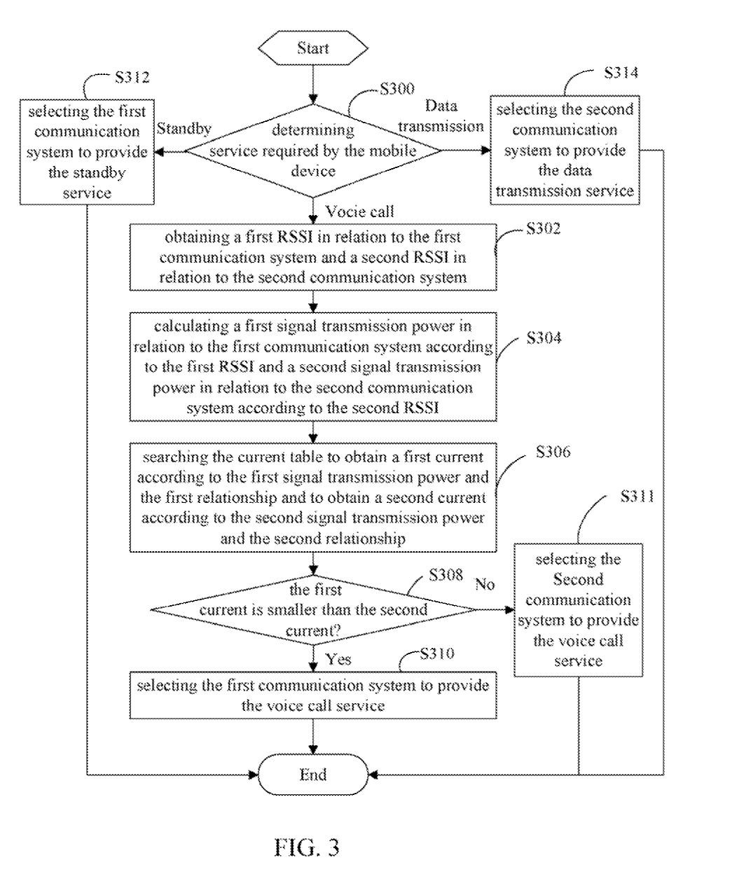

FIG. 3 is a flowchart of a communication system switching method of one embodiment of the present disclosure. The flowchart is executed by the modules of the mobile phone 10 of FIG. 1. Depending on the embodiment, additional blocks may be added, others deleted, and the ordering of blocks may be changed while remaining well within the scope of the disclosure.

In block S300, the service determining module 100 determines if the mobile phone 10 requires a voice call service. If the mobile phone 10 requires the voice call service, then, in block S302, the strength obtaining module 102 obtains a first received signal strength indication (RSSI) in relation to the first communication system 15 and a second RSSI in relation to the second communication system 16.

In block S304, the power calculating module 104 calculates a first signal transmission power in relation to the first communication system 15 according to the first RSSI and a second signal transmission power in relation to the second communication system 16 according to the second RSSI.

In block S306, the table searching module 106 searches the current table 18 to obtain a first current according to the first signal transmission power and the first relationship and to obtain a second current according to the second signal transmission power and the second relationship. In the example of GSM900 communication system of FIG. 2, the table searching module 106 transforms the first signal transmission power to the corresponding power level and then searches the current table according to the corresponding power level to obtain the corresponding current.

Then, in block S308, the system selecting module 108 compares the first current and the second current. Then, the system selecting module 108 selects one of the communication systems which needs smaller current of the first current and the second current to provide the voice call service. In detail, if the first current is smaller than the second current, then in block S310, the system selecting module 108 selects the first communication system 15 to provide the voice call service. If the first current is larger than the second current, then in block S311, the system selecting module 108 selects the second communication system 16 to provide the voice call service.

In the example of FIG. 2, if the current required by GSM900 is smaller than the current required by WCDMA BANDI, the system selecting module 108 selects GSM900 to provide the voice call service. If the current required by GSM900 is larger than the current required by WCDMA BANDI, the system selecting module 108 selects WCDMA BANDI to provide the voice call service.

If the mobile phone 10 requires a standby service, then in block S312, the system selecting module 108 selects the first communication system 15 to provide the standby service as the first communication system usually requires less current than other communication systems when the mobile phone 10 is in a standby mode. If the mobile phone 10 requires a data transmission service, then in block S314, the system selecting module 108 selects the second communication system 16 to provide the data transmission service to assure data transmission efficiency.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A mobile phone, comprising:
a first communication system;
a second communication system;
a processor; and
a storage system storing a current table which stores a first relationship between current and signal transmission power in relation to the first communication system and a second relationship between current and signal transmission power in relation to the second communication system, and one or more software programs in the form of computerized codes operable to be executed by the processor, the one or more software programs comprising:
a service determining module for determining if the mobile phone requires a voice call service according to user input;
a strength obtaining module for obtaining a first received signal strength indication in relation to the first communication system and a second received signal strength indication in relation to the second communication system if the mobile phone requires the voice call service;
a power calculating module for calculating a first signal transmission power in relation to the first communication system according to the first received signal strength indication and a second signal transmission power in relation to the second communication system according to the second received signal strength indication;
a table searching module for searching the current table to obtain a first current according to the first signal transmission power and the first relationship and a second current according to the second signal transmission power and the second relationship; and
a system selecting module for selecting one of the first communication system and the second communication system to provide the voice call service based on a smaller one of the first current and the second current.

2. The method as claimed in claim 1, wherein the first communication system is a GSM system, the second communication system is selected one from a CDMA2000 system, a WCDMA system, a TD-SCDMA system, a LTE system, and a WIMAX system.

3. The method as claimed in claim 2, wherein the system selecting module is further for selecting the first communication system to provide a standby service.

4. The method as claimed in claim 2, wherein the system selecting module is further for selecting the second communication system to provide a data transmission service.

5. A communication system switching method of a mobile phone comprising a first communication system and a second communication system, the method comprising:
providing a current table which stores a first relationship between current and signal transmission power in relation to the first communication system and a second relationship between current and signal transmission power in relation to the second communication system;
determining if the mobile phone requires a voice call service according to user input;
obtaining a first received signal strength indication in relation to the first communication system and a second received signal strength indication in relation to the second communication system if the mobile phone requires voice call service;
calculating a first signal transmission power in relation to the first communication system according to the first received signal strength indication and a second signal transmission power in relation to the second communication system according to the second received signal strength indication;
searching the current table to obtain a first current according to the first signal transmission power and the first relationship and to obtain a second current according to the second signal transmission power and the second relationship;
comparing the first current and the second current; and
selecting one of the first communication system and the second communication system to provide the voice call service based on a smaller one of the first current and the second current.

6. The method as claimed in claim 5, wherein the first communication system is a GSM system, the second communication system is selected one from a CDMA2000 system, a WCDMA system, a TD-SCDMA system, a LTE system, and a WIMAX system.

7. The method as claimed in claim 6, further comprising:
determining if the mobile phone requires a standby service; and
selecting the first communication system to provide the standby service.

8. The method as claimed in claim 6, further comprising:
determining if the mobile phone requires a data transmission service; and
selecting the second communication system to provide the data transmission service.
